(19) United States
(12) Patent Application Publication
(10) Pub. No.: US 2025/0359595 A1
(43) Pub. Date: Nov. 27, 2025

(54) ATOMIZER AND ELECTRONIC ATOMIZATION DEVICE

(71) Applicant: SHENZHEN SMOORE TECHNOLOGY LIMITED, Shenzhen (CN)

(72) Inventors: Jiajun DU, Shenzhen (CN); Haoliang ZHU, Shenzhen (CN); Yan LIN, Shenzhen (CN); Yu ZHOU, Shenzhen (CN)

(21) Appl. No.: 19/217,422

(22) Filed: May 23, 2025

(30) Foreign Application Priority Data
May 27, 2024 (CN) 202421179026.2

(51) Int. Cl. A24F 40/485; A24F 40/10; A24F 40/42; A24F 40/46; H05B 6/10

(52) U.S. Cl. CPC A24F 40/485; A24F 40/10; A24F 40/42; A24F 40/46; H05B 6/108

(57) ABSTRACT

An atomizer includes: a liquid storage cavity for storing a liquid aerosol-generating material; and an atomization core arranged in the liquid storage cavity, the atomization core including: an outer tube arranged in the liquid storage cavity, at least one first liquid inlet hole in liquid communication with the liquid storage cavity being provided on the outer tube, a liquid storage member arranged in the outer tube so as to guide liquid, a center channel being provided in the liquid storage member, and an atomization assembly arranged in the center channel, the atomization assembly absorbing an aerosol-generating material transported by the liquid storage member and heating and atomizing the aerosol-generating material. Air path communication is formed between the liquid storage cavity and an outside so as to maintain the atomization assembly in an adequate state for absorbing the aerosol-generating material.

### CROSS-REFERENCE TO PRIOR APPLICATION

Priority is claimed to Chinese Patent Application No. 202421179026.2, filed on May 27, 2024, the entire disclosure of which is hereby incorporated by reference herein.

### FIELD

This application relates to the field of atomization technologies, and in particular, to an atomizer and an electronic atomization device.

### BACKGROUND

An electronic atomization device is a device configured to generate an aerosol.

In the related art, an atomizer includes a liquid storage cavity and an atomization core; a liquid storage member and an atomization assembly are arranged in the atomization core; and an aerosol-generating material in the liquid storage cavity may flow to the liquid storage member, the aerosol-generating material is guided to the atomization assembly through the liquid storage member, and then the aerosol-generating material is heated and atomized by the atomization assembly.

A pressure change in the liquid storage cavity may cause insufficient liquid flowing from the liquid storage cavity. Consequently, the aerosol generated by the electronic atomization device is not dense enough, and concentration attenuation is serious during continuous generation of the aerosol.

### SUMMARY

In an embodiment, the present invention provides an atomizer, comprising: a liquid storage cavity configured to store a liquid aerosol-generating material; and an atomization core arranged in the liquid storage cavity, the atomization core comprising: an outer tube arranged in the liquid storage cavity, at least one first liquid inlet hole in liquid communication with the liquid storage cavity being provided on the outer tube, a liquid storage member arranged in the outer tube so as to guide liquid, a center channel being provided in the liquid storage member, and an atomization assembly arranged in the center channel, the atomization assembly being configured to absorb an aerosol-generating material transported by the liquid storage member and to heat and atomize the aerosol-generating material, wherein air path communication is formed between the liquid storage cavity and an outside so as to maintain the atomization assembly in an adequate state for absorbing the aerosol-generating material.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a structural exploded view of an electronic atomization device according to Embodiment 1 of this application;

FIG. 2 is a structural exploded view of an atomization core according to Embodiment 1 of this application;

FIG. 3 is a longitudinal cross-sectional view of an atomization core according to Embodiment 1 of this application;

FIG. 4 is an enlarged view of content framed by a circular frame pointed to by an arrow A in FIG. 3;

FIG. 5 is a schematic structural diagram of a base from a first perspective according to Embodiment 1 of this application;

FIG. 6 is a schematic diagram of the back surface of the base shown in FIG. 5;

FIG. 7 is a longitudinal cross-sectional view of an atomization core according to Embodiment 2 of this application;

FIG. 8 is a transverse cross-sectional view of an atomization core according to Embodiment 2 of this application;

FIG. 9 is a schematic structural diagram of a liquid storage member according to Embodiment 2 of this application;

FIG. 10 is a longitudinal cross-sectional view of an atomizer according to Embodiment 3 of this application;

FIG. 11 is a transverse cross-sectional view of an atomizer according to Embodiment 3 of this application;

FIG. 12 is an enlarged view of content framed by a circular frame pointed to by an arrow B in FIG. 10;

FIG. 13 is a longitudinal cross-sectional view of the partial structure of an atomizer according to Embodiment 4 of this application; and

FIG. 14 is a schematic structural diagram of a liquid injection valve according to Embodiment 4 of this application.

### DETAILED DESCRIPTION

In an embodiment, the present invention provides a modified atomizer and an electronic atomization device.

In an embodiment, the present invention provides an atomizer that includes a liquid storage cavity configured to store a liquid aerosol-generating material, and an atomization core arranged in the liquid storage cavity. The atomization core includes:
an outer tube, arranged in the liquid storage cavity, where at least one first liquid inlet hole in liquid communication with the liquid storage cavity is provided on the outer tube;
a liquid storage member, arranged in the outer tube for liquid guiding, where a center channel is provided in the liquid storage member; and
an atomization assembly, arranged in the center channel for absorbing an aerosol-generating material transported by the liquid storage member and heating and atomizing the aerosol-generating material, where
air path communication is formed between the liquid storage cavity and the outside, to maintain the atomization assembly in an adequate state for absorbing the aerosol-generating material.

In some embodiments, an air inlet end in communication with the outside is arranged on the atomizer, and the air inlet end is in air communication with the center channel;
at least one first air channel through which the first liquid inlet hole is in air communication with the center channel is provided in the atomization core; and the liquid storage cavity is in communication with the outside through the first air channel.

In some embodiments, the first air channel is provided between the outer tube and the center channel. In some embodiments, at least one first air guide groove is provided on the liquid storage member, to form the first air channel;
the first air guide groove is in communication with the center channel through a pore structure on the liquid storage member; and the at least one first air guide groove is provided opposite to the at least one first liquid inlet hole in the radial direction of the outer tube.

In some embodiments, a plurality of first air guide grooves circumferentially arranged are provided on the surface of the liquid storage member facing the outer tube; and each first air guide groove is in an elongated shape, and the length direction of the first air guide groove is the same as the axial direction of the liquid storage member.

In some embodiments, the atomization core further includes an inner tube between the outer tube and the liquid storage member, the first liquid inlet hole is located on the periphery of the inner tube, and a second liquid inlet hole in liquid communication with the first liquid inlet hole is further provided on the inner tube; and
gap space is provided between the outer tube and the inner tube, to form the first air channel.

In some embodiments, the end of the inner tube away from the first liquid inlet hole is between the two ends of the liquid storage member.

In some embodiments, the atomization core further includes a base mounted in the outer tube, the liquid storage member is placed on the base, and the first liquid inlet hole is provided on the periphery of the base; and
a second air guide groove is provided on the base, an opening at one end of the second air guide groove is in communication with the air inlet end, and an opening at the other end of the second air guide groove is in air communication with the first liquid inlet hole, to form the first air channel.

In some embodiments, the openings at the two ends of the second air guide groove are respectively provided on two opposite sides of the base in the circumferential direction; and a connection groove section connecting the openings at the two ends is further provided on the second air guide groove, and the connection groove section is provided on the periphery of the base and extends in the circumferential direction of the base.

In some embodiments, liquid storage space is provided between the first liquid inlet hole and the base.

In some embodiments, the atomizer includes a liquid injection hole in communication with the liquid storage cavity, and the liquid injection hole is configured for injecting the aerosol-generating material into the liquid storage cavity from the outside;
the atomizer further includes a liquid injection valve configured to block the liquid injection hole; and a second air channel through which the liquid storage cavity is in air communication with the outside is provided on the liquid injection valve.

In some embodiments, the second air channel includes at least one first ventilation section through which the liquid storage cavity is in air communication with the outside; and
the second air channel further includes at least one annular section circumferentially provided around the liquid injection valve, and each annular section is in communication with at least one first ventilation section.

An electronic atomization device is further constructed in this application. The electronic atomization device includes an electronic control assembly, and further includes the foregoing atomizer; and the electronic control assembly is electrically connected to a heating member of the atomizer.

The beneficial effects of implementing this application are as follows: In the atomizer, it is designed that the air path communication is formed between the liquid storage cavity and the outside, to balance the pressure difference between the liquid storage cavity and the outside during the inhalation, to ensure that the atomization assembly is in an adequate state, thereby alleviating or resolving the problems of insufficient aerosol concentration and taste attenuation in long inhalation.

### LIST OF REFERENCE NUMERALS

Atomizer 100; electronic control assembly 200;
liquid storage cavity 1; atomization core 2; outer tube 21; first liquid inlet hole 211; liquid storage member 22; center channel 221; first air guide groove 222; atomization assembly 23; inner guide member 231; main body portion 2311; protruding portion 2312; heating member 232; mounting base 233; liquid guide opening 2331; base 24; bore channel 241; second air guide groove 242; connection groove section 2421; first cylinder section 243; second cylinder section 244; liquid storage space 25; inner tube 26; second liquid inlet hole 261; gap space 27; airflow channel 3; air inlet end 31; air outlet end 32; first air channel 4; seal member 5; holder 6; liquid injection hole 61; liquid injection valve 62; first column section 621; second column section 622; second air channel 63; first ventilation section 631; and annular section 632.

In order to have a clearer understanding of the technical features, the objectives, and the effects of this application, specific implementations of this application are now illustrated in detail with reference to the accompanying drawings. In the following descriptions, it should be understood that orientation or position relationships indicated by the terms such as “front”, “rear”, “upper”, “lower”, “left”, “right”, “longitudinal”, “transverse”, “vertical”, “horizontal”, “top”, “bottom”, “inner”, “outer”, “head”, and “tail” are based on orientation or position relationships shown in the accompanying drawings, and are used only for case of description of the technical solution, rather than indicating that the mentioned apparatus or element must have a particular orientation or be constructed and operated in a particular orientation. Therefore, such terms should not be construed as a limitation to this application.

Further, it should be noted that, unless otherwise explicitly specified and defined, terms such as “mounted”, “connected”, “connection”, “fixed”, and “arranged” should be understood in a broad sense. For example, the connection may be a fixed connection, a detachable connection, or an integral connection; or the connection may be a mechanical connection or an electrical connection; or the connection may be a direct connection, an indirect connection through an intermediary, or internal communication between two elements or an interaction relationship between two elements. When one element is referred to as being “above” or “below” another element, the element can be “directly” or “indirectly” located on the another element, or there may be one or more intervening elements. Terms such as “first”, “second”, and “third” are used merely for ease of describing the technical solution, and shall not be construed as indicating or implying relative importance or implying a quantity of indicated technical features. Therefore, a feature defined by “first”, “second”, “third”, or the like may explicitly indicate or implicitly include one or more such features. A person of ordinary skill in the art can understand the specific meanings of the foregoing terms in this application according to specific situations.

In the following descriptions, for the purpose of illustration rather than limitation, specific details such as the specific system structure and technology are proposed to thoroughly understand the embodiments of this application. However, a person skilled in the art should know that this application may be implemented in other embodiments without these specific details. In other cases, detailed descriptions of well-known systems, apparatuses, circuits, and methods are omitted to avoid unnecessary details hindering the descriptions of this application.

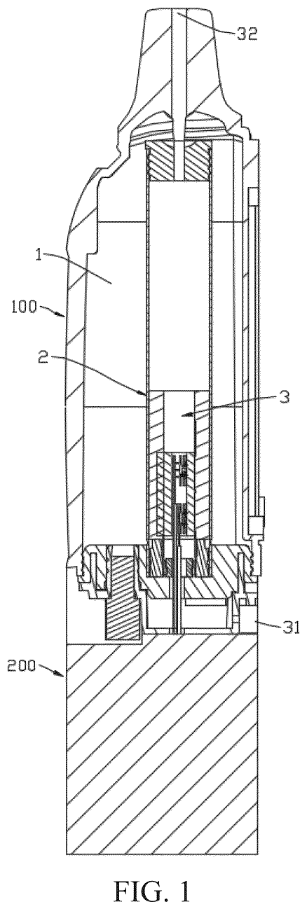

This application provides an electronic atomization device. The electronic atomization device may be configured to atomize an aerosol-generating material. Referring to FIG. 1, the electronic atomization device may include an atomizer 100 and an electronic control assembly 200 that are electrically connected to each other.

The atomizer 100 is configured to store a liquid aerosol-generating material, and heat and atomize the aerosol-generating material, to form an inhalable aerosol for a user. The atomizer 100 may be specifically used in different fields such as medical care, cosmetology, and recreation inhalation. An example in which the aerosol generated by the atomizer 100 is inhaled by the user is used for description of the atomizer 100 in this application.

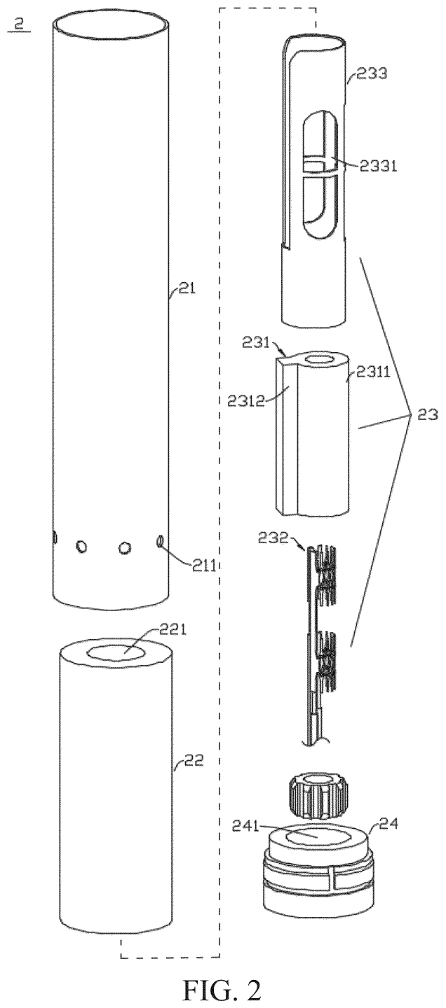

As shown in FIG. 1, the atomizer 100 may include a liquid storage cavity 1 configured to store the liquid aerosol-generating material, and an atomization core 2 arranged in the liquid storage cavity 1. A liquid flowing channel may be formed between the liquid storage cavity 1 and the atomization core 2, so that the aerosol-generating material in the liquid storage cavity 1 may flow to the atomization core 2, and the aerosol-generating material is heated by the atomization core 2. In addition, an airflow channel 3 is formed in the electronic atomization device. The air in the outside may flow in from one end (namely, an air inlet end 31) of the airflow channel 3 and flow out from the other end (namely, an air outlet end 32) of the airflow channel 3, to bring out an atomized aerosol-generating material. In some embodiments, referring to FIG. 2, the atomization core 2 may include an outer tube 21, a liquid storage member 22, and an atomization assembly 23. The outer tube 21 may be arranged in the liquid storage cavity 1, and at least one first liquid inlet hole 211 in liquid communication with the liquid storage cavity 1 is provided on the outer tube 21. The liquid communication may be understood as being liquid-passable. The liquid storage member 22 may be arranged in the outer tube 21, and is configured to absorb an aerosol-generating material flowing from the first liquid inlet hole 211 and transport the aerosol-generating material to the atomization assembly 23. In addition, a center channel 221 for forming the part of the airflow channel 3 is provided in the liquid storage member 22. The atomization assembly 23 may be arranged at the center channel 221 of the liquid storage member 22, and is configured to absorb the aerosol-generating material transported by the liquid storage member 22 and heat and atomize the aerosol-generating material.

In addition, in design of this application, air path communication is formed between the liquid storage cavity 1 and the outside, to balance the pressure difference between the liquid storage cavity 1 and the outside during the inhalation, to ensure that the atomization assembly 23 is in an adequate state of absorbing the aerosol-generating material during the inhalation. The adequate state may be understood as that with the amount of aerosol-generating material on the atomization assembly 23, an aerosol with a preset concentration or an aerosol with a concentration greater than the preset concentration can be generated. The preset concentration described herein may be adjusted according to an actual requirement. When the amount of the aerosol-generating material on the atomization assembly 23 is insufficient, if heating is continuously performed, the concentration and the taste of the aerosol are affected, and a dry heating phenomenon may be even caused. In addition, because the liquid storage cavity 1 is generally closed space, the pressure of the liquid storage cavity 1 gradually decreases during liquid flowing, and a difference of pressure inside and outside the liquid storage cavity 1 gradually increases, resulting in reduction of the liquid flowing amount of the aerosol-generating material in the liquid storage cavity 1, further resulting in the insufficient aerosol-generating material on the atomization assembly 23. If the adequate state of the atomization assembly 23 for absorbing the aerosol-generating material can be maintained, the foregoing problems of insufficient aerosol concentration and taste attenuation in long inhalation can be resolved.

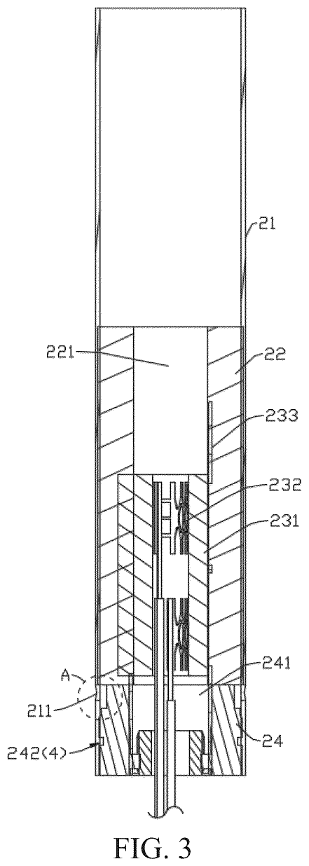

Optionally, an air path formed between the liquid storage cavity 1 and the outside may be formed in the atomization core 2, and performs a function of ventilation by communicating the first liquid inlet hole 211 with the airflow channel 3. In some embodiments, referring to FIG. 3, one or more first air channels 4 through which the first liquid inlet hole 211 is in air communication with the center channel 221 of the liquid storage member 22 are provided in the atomization core 2. The air communication may be understood as being gas-passable.

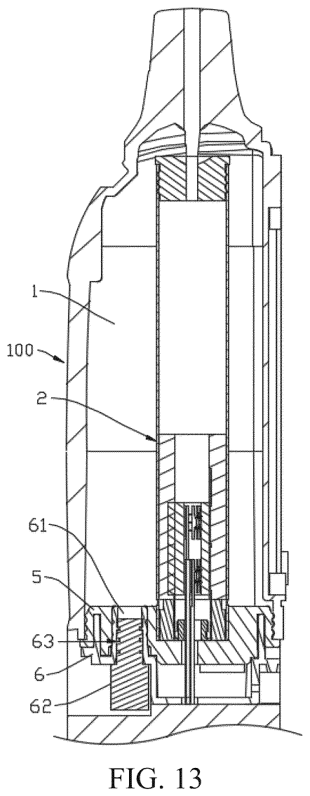

Further, optionally, the air path formed between the liquid storage cavity 1 and the outside may be provided at the liquid storage cavity 1, to achieve the objective of ventilation by directly communicating the liquid storage cavity 1 with the outside. In some embodiments, referring to FIG. 13, the electronic atomization device includes a liquid injection hole 61 in communication with the liquid storage cavity 1, and a liquid injection valve 62 configured to block the liquid injection hole 61. The aerosol-generating material may be injected/supplied into the liquid storage cavity 1 from the outside through the liquid injection hole 61. One or more second air channels 63 through which the liquid storage cavity 1 is directly in air communication with the outside are provided on the liquid injection valve 62.

It should be noted that, the first air channel 4/the second air channel 63 is a channel through which gas can flow but liquid cannot flow. For example, the air path is a capillary pore. It may be understood that, liquid has surface tension, and when the diameter of the air path is small to a specific extent, the liquid cannot enter the air path due to the surface tension. In this way, a phenomenon of liquid leakage caused by ventilation can be effectively avoided. For a specific value of the diameter of the air path, refer to the related art. Details are not described herein.

In addition, the electronic control assembly 200 may include a battery and a controller. The battery is configured to supply electric energy for operation of the atomizer 100. The controller is configured to control operation of the atomizer 100. For a specific structure of the controller and a control method, refer to the related art. Details are not described herein. The electronic control assembly 200 may further include other components such as a battery holder and an airflow sensor. Details are not described herein.

The structure of the atomizer 100 and the forming location of the air path for ventilation in some embodiments of this application are described below with examples. For case of describing the atomizer 100 in this application, in the following, referring to FIG. 1, the side of a structure close to the air outlet end 32 of the atomizer 100 is referred to as the top portion/top end, and the side of the structure away from the air inlet end 31 of the atomizer 100 is referred to as the bottom portion/bottom end.

### Embodiment 1

Referring to FIG. 2 and FIG. 3, an atomizer 100 includes a liquid storage cavity 1 and an atomization core 2. The atomization core 2 includes an outer tube 21, a liquid storage member 22, and an atomization assembly 23. For a cooperation relationship among these structures and the functions of these structures, refer to the descriptions above. Details are not described herein again.

As shown in FIG. 2, the outer tube 21 may be in a cylinder shape. Certainly, the outer tube 21 may alternatively be in another shape, for example, a square cylinder shape. This is not limited herein. A plurality of first liquid inlet holes 211 are provided on the periphery of the outer tube 21.

The liquid storage member 22 may also be in a cylinder shape, to define a center channel 221. Certainly, the liquid storage member 22 may alternatively be in another shape, for example, a square cylinder shape. This is not limited herein. As shown in FIG. 3, the outer diameter of the liquid storage member 22 is equal to the inner diameter of the outer tube 21, so that the outer circumferential side surface of the liquid storage member 22 may be in contact with the inner circumferential side surface of the outer tube 21.

Referring to FIG. 2 and FIG. 3, the atomization assembly 23 may include an inner guide member 231 and a heating member 232 connected to the inner guide member 231. The outer side surface of the inner guide member 231 may be in contact with the liquid storage member 22, to transport an aerosol-generating material. The heating member 232 may be arranged on the inner circumference of the inner guide member 231, to heat the aerosol-generating material on the inner guide member 231.

The axial length of the inner guide member 231 may be smaller than the axial length of the liquid storage member 22. Two axial ends of the inner guide member 231 may be between two axial ends of the liquid storage member 22.

The inner guide member 231 may include a main body portion 2311 in a cylinder shape, and a protruding portion 2312 protruding from the side of the main body portion 2311 in the circumferential direction. The outer diameter of the main body portion 2311 is equal to the inner diameter of the liquid storage member 22, so that the outer circumferential side surface of the main body portion 2311 may be attached to the inner circumferential side surface of the liquid storage member 22. The protruding portion 2312 may be embedded in the liquid storage member 22. In this case, stability of the inner guide member 231 fixed in the liquid storage member 22 can be effectively improved. In addition, a contact area between the inner guide member 231 and the liquid storage member 22 can be increased, which facilitates liquid flowing.

The heating member 232 may include one or more heating circuits, and electrode portions respectively arranged on the two sides of each heating circuit in the length direction of the heating circuit. The heating circuit is a sheet structure, and is arranged to be curled and attached to the inner circumferential side surface of the inner guide member 231. When a plurality of heating circuits are arranged, the plurality of heating circuits may be arranged at intervals in the axial direction of the inner guide member 231. The electrode portion is configured to be connected to a power supply.

The atomization assembly 23 may further include a cylindrical mounting base 233, configured to provide the basis for mounting the inner guide member 231 on the liquid storage member 22. The mounting base 233 may be sleeved on the outer circumference of the inner guide member 231, and the mounting base 233 is embedded in the liquid storage member 22, to fix the inner guide member 231 in the liquid storage member 22.

A plurality of liquid guide openings 2331 are also provided on the periphery of the mounting base 233, and are provided for transmitting the aerosol-generating material in the liquid storage member 22 to the inner guide member 231.

As shown in FIG. 3, the atomization core 2 may further include a base 24. The base 24 is mounted in the outer tube 21, and blocks the part of an opening at the bottom end of the outer tube 21. The base 24 may be a plastic member; and the base 24 may be mounted in the outer tube 21 in a riveting manner during assembly.

The base 24 may be a cylindrical structure, and the maximum outer diameter of the base 24 may be equal to the inner diameter of the outer tube 21, for sealing the inner circumferential edge of the outer tube 21. In addition, a bore channel 241 provided in the base 24 may communicate the center channel 221 of the liquid storage member 22 with the outside of the outer tube 21, to form the part of an airflow channel 3.

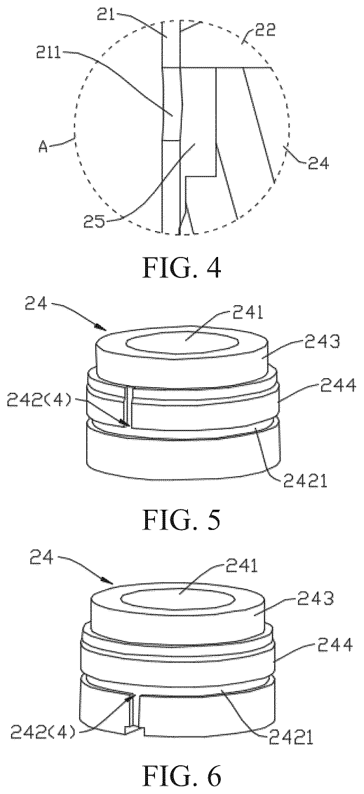

The liquid storage member 22 may be placed on the top portion of the base 24, and the bottom portion of the liquid storage member 22 may abut against the top portion of the base 24. The bottom end of the mounting base 233 may be inserted into the bore channel 241 of the base 24. In this embodiment, referring to FIG. 4, the first liquid inlet hole 211 is located on the periphery of the base 24. In addition, liquid storage space 25 is provided between the first liquid inlet hole 211 and the base 24. The liquid storage space 25 may cause the aerosol-generating material to more easily flow to the liquid storage member 22, thereby shortening waiting time required for inhalation. The liquid storage space 25 is located on the side of the liquid storage member 22 facing the base 24; and the aerosol-generating material may enter from the first liquid inlet hole 211, and reach the liquid storage member 22 after passing through the liquid storage space 25.

Referring to FIG. 3, a second air guide groove 242 is further provided on the base 24. One end of the second air guide groove 242 is in communication with an air inlet end 31, and the other end of the second air guide groove 242 is in air communication with the first liquid inlet hole 211, to form a first air channel 4.

Optionally, referring to FIG. 5 and FIG. 6, the base 24 may include a first cylinder section 243 and a second cylinder section 244 that are axially connected. The first cylinder section 243 is closer to the liquid storage member 22 than the second cylinder section 244. The outer diameter of the second cylinder section 244 may be equal to the inner diameter of the outer tube 21. In addition, the outer diameter of the first cylinder section 243 is less than the inner diameter of the outer tube 21, so that the foregoing liquid storage space 25 is formed between the outer side wall of the first cylinder section 243 and the inner side wall of the outer tube 21. The liquid storage space 25 is in an annular shape. Alternatively, the first cylinder section 243 may be radially arranged opposite to the first liquid inlet hole 211.

The second air guide groove 242 may be formed on the second cylinder section 244, where the two ends of the second air guide groove 242 are designed as openings, and the openings at the two ends may be respectively arranged on two axial end surfaces of the second cylinder section 244. Airflow may flow into the second air guide groove 242 from the bottom end surface of the second cylinder section 244, flow out from the end surface of the second cylinder section 244, sequentially pass through the liquid storage space 25 and the first liquid inlet hole 211, and reach the liquid storage cavity 1, to implement ventilation.

Preferably, the openings at the two ends of the second air guide groove 242 may be provided on two opposite sides of the base 24 in the circumferential direction. A connection groove section 2421 configured to connect the openings at the two ends is further provided on the second air guide groove 242. The connection groove section 2421 is arranged on the outer periphery of the second cylinder section 244, and extends in the circumferential direction of the second cylinder section 244.

This design can effectively avoid liquid leakage. Even if the aerosol-generating material accidentally flows into the second air guide groove 242, the aerosol-generating material remains only at the connection groove section 2421 of the second air guide groove 242, and it is hard for the aerosol-generating material to flow out from the bottom end surface of the second cylinder section 244. Optionally, the connection groove section 2421 is in a circular ring shape, and the center of the connection groove section 2421 is located on the central axis of the base 24.

### Embodiment 2

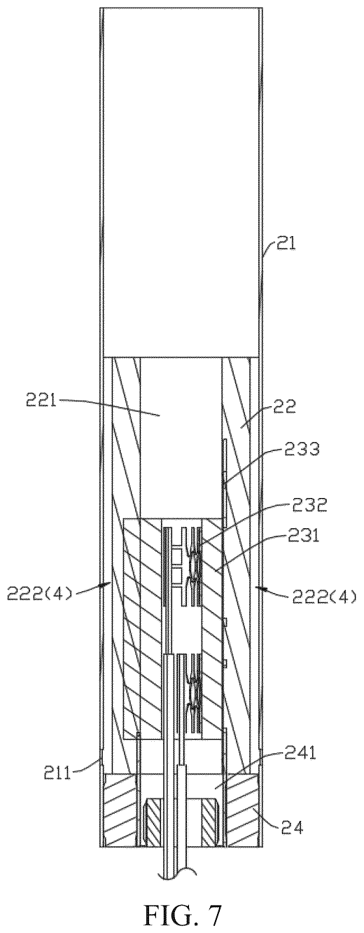

Referring to FIG. 7, an atomizer 100 in this embodiment is a modification based on Embodiment 1.

The main modifications are the formation location of a first air channel 4 and the relative location of a first liquid inlet hole 211. The structures of the atomizer 100 in Embodiment 2 that are different from the structures in Embodiment 1 are described below. For the remaining structures of the atomizer 100 not mentioned, refer to Embodiment 1. Details are not described herein again.

In this embodiment, as shown in FIG. 7, the first liquid inlet hole 211 is located on the outer periphery of a liquid storage member 22, and is relatively located on the side of a base 24 facing the liquid storage member 22. The base 24 is a cylindrical structure, and the outer circumferential side wall of the base 24 is attached to the inner circumferential side wall of an outer tube 21, to perform a sealing function.

As shown in FIG. 7, at least one first air guide groove 222 is provided on the liquid storage member 22, to form the first air channel 4. The first air guide groove 222 is in communication with a center channel 221 of the liquid storage member 22 through a pore structure on the liquid storage member 22. In addition, the at least one first air guide groove 222 is provided opposite to at least one first liquid inlet hole 211 in the radial direction of the outer tube 21. It may be understood that, airflow flowing from an air inlet end 31 may sequentially pass through the center channel 221 of the liquid storage member 22, the pore structure of the liquid storage member 22, the first air guide groove 222, the first liquid inlet hole 211, and the liquid storage cavity 1, to implement ventilation. In addition, the first air guide groove 222 is provided opposite to the first liquid inlet hole 211, so that the same effect as the foregoing liquid storage space 25 can be achieved, and waiting time for inhalation can be shortened.

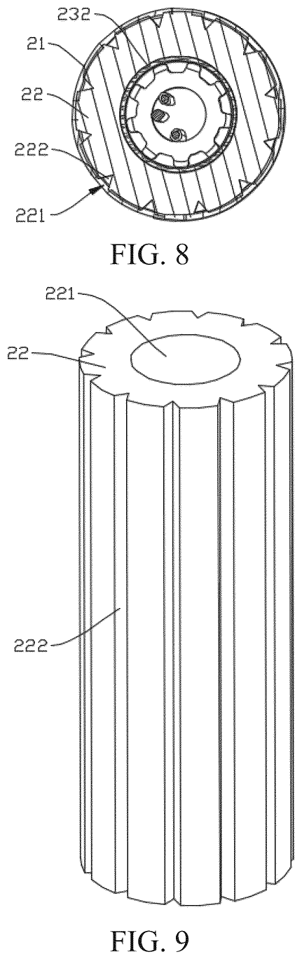

Optionally, referring to FIG. 8 and FIG. 9, a plurality of first air guide grooves 222 circumferentially arranged may be provided on the surface of the liquid storage member 22 facing the outer tube 21. The first air guide grooves may be provided in a manner in which grooves are dug on the surface of the liquid storage member 22, or convex edges are arranged on the liquid storage member 22. Each first air guide groove 222 is in an elongated shape, and the length direction of the first air guide groove 222 is the same as the axial direction of the liquid storage member 22. In addition, the quantity of the first air guide grooves 222 may be greater than the quantity of the first liquid inlet holes 211, and some first air guide grooves 222 in the plurality of first air guide grooves 222 may be respectively provided opposite to the first liquid inlet holes 211 in the radial direction of the outer tube 21. Certainly, the quantity of the first air guide grooves 222 may alternatively be the same as the quantity of the first liquid inlet holes 211, and each first air guide groove 222 is correspondingly provided opposite to each first liquid inlet hole 211 in the radial direction of the outer tube 21. This is not limited herein.

### Embodiment 3

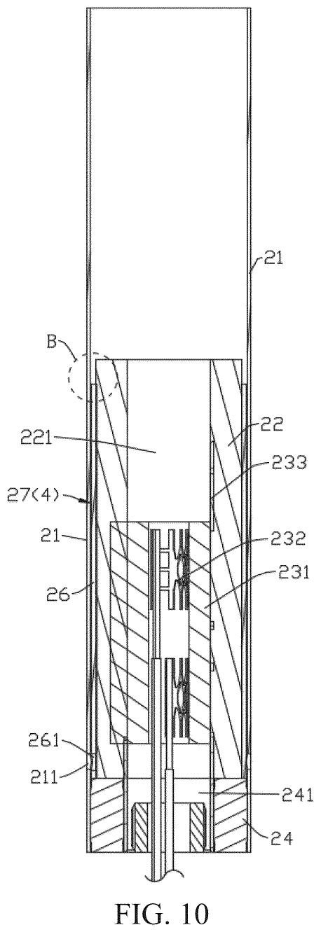

Referring to FIG. 10, an atomizer 100 in this embodiment is a modification based on Embodiment 1. The main modifications are the formation location of a first air channel 4 and the relative location of a first liquid inlet hole 211. The structures of the atomizer 100 in Embodiment 3 that are different from the structures in Embodiment 1 are described below. For the remaining structures of the atomizer 100 not mentioned, refer to Embodiment 1. Details are not described herein again.

In this embodiment, as shown in FIG. 10, the first liquid inlet hole 211 is located on the outer periphery of a liquid storage member 22, and is relatively located on the side of a base 24 facing the liquid storage member 22. The base 24 is a cylindrical structure, and the outer circumferential side wall of the base 24 is attached to the inner circumferential side wall of an outer tube 21, to perform a sealing function.

An atomization core 2 further includes an inner tube 26 between the outer tube 21 and the liquid storage member 22, and the inner tube 26 may be placed on the base 24 like the liquid storage member 22. In this case, the first liquid inlet hole 211 is relatively located on the outer periphery of the inner tube 26.

Gap space 27 is provided between the inner tube 26 and the outer tube 21, to form the first air channel 4; and the gap space 27 is configured for communicating a center channel 221 of the liquid storage member 22 with the first liquid inlet hole 211. It may be understood that, airflow entering from an air inlet end 31 may sequentially pass through the center channel 221 of the liquid storage member 22, the gap space 27, the first liquid inlet hole 211, and a liquid storage cavity 1, to implement ventilation. Because a location between the base 24 and the outer tube 21 is sealed, the airflow and liquid do not leak out from the location between the base 24 and the outer tube 21.

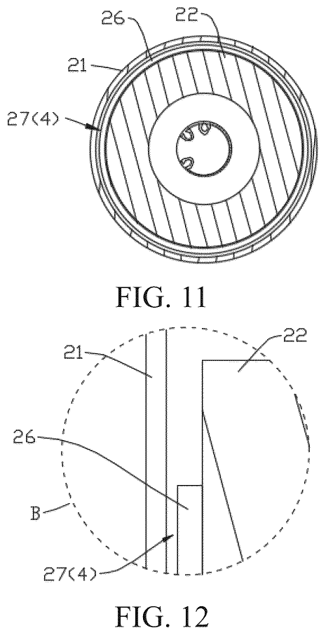

Optionally, referring to FIG. 11, the outer diameter of the inner tube 26 may be slightly less than the outer diameter of the outer tube 21, and the inner tube 26 is coaxially arranged in the outer tube 21, to form the tubular gap space 27 between the inner tube 26 and the outer tube 21. In addition, the inner diameter of the inner tube 26 may be equal to the outer diameter of the liquid storage member 22, so that the outer circumferential side surface of the liquid storage member 22 may be attached to the inner circumferential side surface of the inner tube 26.

Still referring to FIG. 12, the top end of the inner tube 26 may be between the two ends of the liquid storage member 22. In other words, the top end of the inner tube 26 is lower than the top end of the liquid storage member 22. In this case, the airflow entering from the air inlet end 31 may sequentially pass through the center channel 221 of the liquid storage member 22, a pore structure of the liquid storage member 22, the gap space 27, the first liquid inlet hole 211, and the liquid storage cavity 1, to implement ventilation. In this design, time required for ventilation can be shortened.

Referring to FIG. 10, a second liquid inlet hole 261 in liquid communication with the first liquid inlet hole 211 is further provided on the inner tube 26. The quantity of second liquid inlet holes 261 may be the same as the quantity of first liquid inlet holes 211, and each second liquid inlet hole 261 is provided radially opposite to a corresponding first liquid inlet hole 211. An aerosol-generating material in the liquid storage cavity 1 may sequentially flow through the first liquid inlet hole 211 and the second liquid inlet hole 261, and then reach the liquid storage member 22.

### Embodiment 4

Referring to FIG. 13, an atomizer 100 in this embodiment is a modification based on Embodiment 1. The main modification is that the air path formed between the liquid storage cavity 1 and the outside is provided in the liquid storage cavity 1 instead of being provided in the atomization core 2. The structures of an atomization core 2 in Embodiment 4 that are different from the structures in Embodiment 1 are described below. For the remaining structures of the atomization core 2 not mentioned, refer to Embodiment 1. Details are not described herein again.

In this embodiment, as shown in FIG. 13, a first liquid inlet hole 211 of the atomization core 2 is located on the outer periphery of a liquid storage member 22, and is relatively located on the side of a base 24 facing the liquid storage member 22. The base 24 is a cylindrical structure, and the outer circumferential side wall of the base 24 is attached to the inner circumferential side wall of an outer tube 21, to perform a sealing function.

Then, referring to the structure of the liquid storage cavity 1, a seal member 5 is arranged at the bottom portion of the liquid storage cavity 1, and the seal member 5 is configured to block the bottom of the liquid storage cavity 1. The atomization core 2 may be fixedly mounted on the seal member 5, to cause the atomization core 2 to be fixed in the liquid storage cavity 1.

A holder 6 is further arranged on the side of the seal member 5 away from the liquid storage cavity 1, and the seal member 5 may be mounted on the holder 6. A liquid injection hole 61 in communication with the liquid storage cavity 1 is provided on the holder 6. One end of the liquid injection hole 61 is in communication with the liquid storage cavity 1, and the other end of the liquid injection hole 61 may be in communication with the outside. A liquid injection valve 62 configured to block the liquid injection hole 61 is further arranged on the holder 6. An aerosol-generating material may be injected/supplied into the liquid storage cavity 1 from the outside through the liquid injection hole 61.

One or more second air channels 63 through which the liquid storage cavity 1 is directly in air communication with the outside are provided on the liquid injection valve 62.

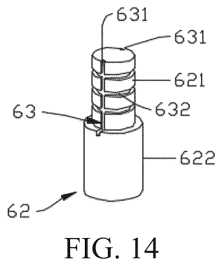

Optionally, referring to FIG. 14, the second air channel 63 may include at least one first ventilation section 631 through which the liquid storage cavity 1 is in air communication with the outside, and at least one annular section 632 circumferentially provided around the liquid injection valve 62. Each annular section 632 is in communication with at least one first ventilation section 631. The annular section 632 may perform a function of the foregoing connection groove section 2421 provided on the base 24 in Embodiment 1, to effectively avoid liquid leakage.

Further, optionally, the liquid injection hole 61 is cylindrical. The liquid injection valve 62 may include a first column section 621 inserted into the liquid injection hole 61, and a second column section 622 that is located outside the liquid injection hole 61 and that is in contact with the air in the outside. A plurality of first ventilation sections 631 may be provided on the liquid injection valve 62, where both ends of each first ventilation section 631 are designed as openings, one end of the first ventilation section 631 is arranged on the surface of the first column section 621 facing the inner part of the liquid storage cavity 1, and the other end of the first ventilation section 631 may be arranged on the surface of the second column section 622 in contact with the air in the outside. The air in the outside may enter from a port on the second column section 622, and flow into the liquid storage cavity 1 from a port on the first column section 621, to implement ventilation. In addition, a plurality of annular sections 632 that are separately recessed on the outer circumferential side surface of the first column section 621 may be further provided on the liquid injection valve 62, where each annular section 632 may be in communication with the first ventilation section 631.

In conclusion, in this application, it is designed that the first air channel 4 is designed in the atomization core 2/the second air channel 63 is designed in the liquid storage cavity 1, to form air path communication between the liquid storage cavity 1 and the outside and balance the pressure difference between the liquid storage cavity 1 and the outside during the inhalation, to maintain the adequate state of the atomization assembly 23 for absorbing the aerosol-generating material, thereby resolving the problems of insufficient aerosol concentration and taste attenuation in long inhalation.

It may be understood that, through the foregoing first air guide groove 222 provided on the liquid storage member 22 in Embodiment 2 and the gap space 27 formed between the outer tube 21 and the inner tube 26 in Embodiment 3, the first air channel 4 is substantially provided between the outer tube 21 and the center channel 221.

In addition, the foregoing second air guide groove 242 provided on the base 24 in Embodiment 1, the first air guide groove 222 provided on the liquid storage member 22 in Embodiment 2, the gap space 27 formed between the outer tube 21 and the inner tube 26 in Embodiment 3, and the second air channel 63 provided on the liquid injection valve 62 in Embodiment 3 can be freely combined on the same electronic atomization device. This is not limited herein.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. An atomizer, comprising:
a liquid storage cavity configured to store a liquid aerosol-generating material; and
an atomization core arranged in the liquid storage cavity, the atomization core comprising:
an outer tube arranged in the liquid storage cavity, at least one first liquid inlet hole in liquid communication with the liquid storage cavity being provided on the outer tube,
a liquid storage member arranged in the outer tube so as to guide liquid, a center channel being provided in the liquid storage member, and
an atomization assembly arranged in the center channel, the atomization assembly being configured to absorb an aerosol-generating material transported by the liquid storage member and to heat and atomize the aerosol-generating material,
wherein air path communication is formed between the liquid storage cavity and an outside so as to maintain the atomization assembly in an adequate state for absorbing the aerosol-generating material.

2. The atomizer of claim 1, wherein an air inlet end in communication with the outside is arranged on the atomizer, the air inlet end being in air communication with the center channel,
wherein at least one first air channel through which the first liquid inlet hole is in air communication with the center channel is provided in the atomization core, and
wherein the liquid storage cavity is in communication with the outside through the first air channel.

3. The atomizer of claim 2, wherein the first air channel is provided between the outer tube and the center channel.

4. The atomizer of claim 3, wherein at least one first air guide groove is provided on the liquid storage member so as to form the first air channel,
wherein the first air guide groove is in communication with the center channel through a pore structure on the liquid storage member, and
wherein the at least one first air guide groove is provided opposite the at least one first liquid inlet hole in a radial direction of the outer tube.

5. The atomizer of claim 4, wherein a plurality of circumferentially arranged first air guide grooves are provided on a surface of the liquid storage member facing the outer tube,
wherein each first air guide groove of the plurality of first air guide grooves has an elongated shape, and
wherein a length direction of the first air guide groove comprises an axial direction of the liquid storage member.

6. The atomizer of claim 3, wherein the atomization core comprises an inner tube between the outer tube and the liquid storage member,
wherein the first liquid inlet hole is located on a periphery of the inner tube,
wherein a second liquid inlet hole in liquid communication with the first liquid inlet hole is provided on the inner tube, and
wherein gap space is provided between the outer tube and the inner tube so as to form the first air channel.

7. The atomizer of claim 6, wherein an end of the inner tube away from the first liquid inlet hole is between two ends of the liquid storage member.

8. The atomizer of claim 2, wherein the atomization core further comprises a base mounted in the outer tube,
wherein the liquid storage member is placed on the base,
wherein the first liquid inlet hole is provided on a periphery of the base,
wherein a second air guide groove is provided on the base,
wherein an opening at one end of the second air guide groove is in communication with the air inlet end, and
wherein an opening at an other end of the second air guide groove is in air communication with the first liquid inlet hole so as to form the first air channel.

9. The atomizer of claim 8, wherein openings at the two ends of the second air guide groove are respectively provided on two opposite sides of the base in a circumferential direction,
wherein a connection groove section connecting the openings at the two ends is provided on the second air guide groove, and
wherein the connection groove section is provided on the periphery of the base and extends in the circumferential direction of the base.

10. The atomizer of claim 8, wherein liquid storage space is provided between the first liquid inlet hole and the base.

11. The atomizer of claim 1, wherein the atomizer includes a liquid injection hole in communication with the liquid storage cavity, and the liquid injection hole is configured for injection of the aerosol-generating material into the liquid storage cavity from the outside,
wherein the atomizer comprises a liquid injection valve configured to block the liquid injection hole, and
wherein a second air channel is provided on the liquid injection valve, through which second air channel the liquid storage cavity is in air communication with the outside.

12. The atomizer of claim 11, wherein the second air channel comprises at least one first ventilation section through which the liquid storage cavity is in air communication with the outside,
wherein the second air channel comprises at least one annular section circumferentially provided around the liquid injection valve, and
wherein each annular section of the at least one annular section is in communication with at least one first ventilation section.

13. The atomizer of claim 1, further comprising:
a heating member comprising at least one heating circuit,
wherein the at least one heating circuit is arranged at intervals in an axial direction of the atomization assembly.

14. An electronic atomization device, comprising:
an electronic control assembly; and
the atomizer of claim 1,
wherein the electronic control assembly is electrically connected to a heating member of the atomizer.

15. The electronic atomization device of claim 14, wherein an air inlet end in communication with the outside is arranged on the atomizer, the air inlet end being in air communication with the center channel,
wherein at least one first air channel through which the first liquid inlet hole is in air communication with the center channel is provided in the atomization core, and
wherein the liquid storage cavity is in communication with the outside through the first air channel.

16. The electronic atomization device of claim 15, wherein the first air channel is provided between the outer tube and the center channel.

17. The electronic atomization device of claim 16, wherein at least one first air guide groove is provided on the liquid storage member so as to form the first air channel,
wherein the first air guide groove is in communication with the center channel through a pore structure on the liquid storage member, and
wherein the at least one first air guide groove is provided opposite the at least one first liquid inlet hole in a radial direction of the outer tube.

18. The electronic atomization device of claim 16, wherein the atomization core comprises an inner tube between the outer tube and the liquid storage member,
wherein the first liquid inlet hole is located on a periphery of the inner tube,
wherein a second liquid inlet hole in liquid communication with the first liquid inlet hole is provided on the inner tube, and
wherein gap space is provided between the outer tube and the inner tube so as to form the first air channel.

19. The electronic atomization device of claim 15, wherein the atomization core further comprises a base mounted in the outer tube,
wherein the liquid storage member is placed on the base,
wherein the first liquid inlet hole is provided on a periphery of the base,
wherein a second air guide groove is provided on the base,
wherein an opening at one end of the second air guide groove is in communication with the air inlet end, and
wherein an opening at an other end of the second air guide groove is in air communication with the first liquid inlet hole so as to form the first air channel.

20. The electronic atomization device of claim 14, wherein the atomizer includes a liquid injection hole in communication with the liquid storage cavity, and the liquid injection hole is configured for injection of the aerosol-generating material into the liquid storage cavity from the outside,
wherein the atomizer comprises a liquid injection valve configured to block the liquid injection hole, and
wherein a second air channel is provided on the liquid injection valve, through which second air channel the liquid storage cavity is in air communication with the outside.
